(19) United States
(12) Patent Application Publication
(10) Pub. No.: US 2025/0154328 A1
(43) Pub. Date: May 15, 2025

(54) PROCESS FOR MAKING EXPANDED POLYMERIC MATERIALS

(71) Applicant: MATERIAS S.R.L., Napoli (IT)

(72) Inventors: Ernesto DI MAIO, Napoli (IT); Fabrizio ERRICHIELLO, Napoli (IT); Aniello CAMMARANO, Ascea (SA) (IT); Luigi NICOLAIS, Ercolano (NA) (IT)

(73) Assignee: MATERIAS S.R.L., Napoli (IT)

(21) Appl. No.: 18/838,859

(22) PCT Filed: Jan. 30, 2023
(86) PCT No.: PCT/IB2023/050770

§ 371 Date: Aug. 15, 2024

(30) Foreign Application Priority Data
Feb. 24, 2022 (IT) 102022000003512

(51) Int. Cl. C08J 9/12; B29B 11/06; B29B 11/16; B29C 44/02; B29C 44/44; B29K 23/00; B29K 75/00; B29K 105/00; B29K 105/12; B33Y 70/00; B33Y 80/00; C08J 9/00

(52) U.S. Cl. CPC C08J 9/122; B29B 11/06; B29B 11/16; B29C 44/02; B29C 44/44; B33Y 70/00; B33Y 80/00; C08J 9/0085; B29K 2023/12; B29K 2075/00; B29K 2105/0005; B29K 2105/12; B29K 2905/02; C08J 2203/06; C08J 2323/12; C08J 2375/04

(57) ABSTRACT

The present invention has as its object a process for making a product comprising a polymeric material expanded by using one or more blowing agents characterized in that said process comprises the following steps: ⋅ to make a preform of polymeric material with a filling degree equal to or less than 90% and thin structures having a thickness equal to or less than 3 mm, preferably equal to or less than 2 mm, ⋅ to make a mold including a cavity, said cavity having the shape of the desired product and dimensions equal to or greater than the overall volume of said preform, ⋅ to insert the preform into said cavity of the mold, ⋅ to solubilize under pressure one or more blowing agents in the preform within said mold cavity, ⋅ to release the pressure, and ⋅ to remove the product comprising the expanded polymeric material from the mold.

### FIELD OF THE INVENTION

The present invention relates to a process for making expanded polymeric materials, and objects/products made from such expanded polymeric materials. In particular, the process comprises a step of making a preform of polymeric material, a solubilization step under pressure of the physical blowing agents in the preform, and an expansion step during which the pressure is released. More in particular, the preform is made with a filling degree equal to or lower than 90%, the solubilisation procedure of the physical blowing agents takes place under heat and under pressure within a mold with the desired shape, and the expansion step takes place by abruptly releasing the pressure.

### STATE OF THE ART

Foam injection molding is a complex polymer processing technology for the mass production of lightweight parts with advanced structural and functional properties. The process has various applications in fields such as medical, automotive and aerospace. To meet the growing consumer demand for greater functionality, advanced foaming processes have been developed that allow the inclusion of blowing agents in the formulation to achieve expanded structures. Through the creation of expanded structures, it is possible to obtain an improvement in functional and/or structural performance as well as a reduction in the weight of the object produced with the same volume and shape. The foam injection molding shows a high potential in the making of objects with less environmental impact (Llewelyn et al., “Advance in Microcellular Injection Moulding, Journal of Cellular Plastics, Volume 56 Issue 6, Pages 646-674, 2020).

The process consists in the injection molding of a stable, high-pressure polymer/blowing agent solution, which is allowed to foam in the mold where the solution is brought to a supersaturated state by an abrupt pressure reduction.

The complexity lies in the transition from continuous (extrusion) to discontinuous (injection), characteristic of this technology, and in the correct management of the solution at different processing stages. In fact, the polymer/blowing agent solution tends to phase separate when, for example, the processing pressure, p, drops below the equilibrium pressure, pₑ=pₑ (ω_{AE}, T), which is the pressure of the blowing agent in equilibrium with the solution at the generic processing temperature, T, and composition ω_{AE} (i.e.: in terms of mass flow fraction dosed by the feed system).

In the event that p<pₑ at any point and at any time before the final pressure release, the consequent premature foaming/phase separation, even if only partial, may cause heterogeneity in the final foam morphology, with coexistence of prematurely formed bubbles and those formed at the final pressure release within the mold.

Heterogeneities due to premature foaming are, in general, detrimental to the morphology and final appearance of the foam, as well as to the resulting foam properties, both structural and functional. Numerous developments have been proposed in the technical and scientific literature to prevent the premature formation of bubbles/foam in injection molding: counter-pressure control valves (to avoid pressure drops in the cylinder residue after injection), duct geometry design (to avoid stagnation points), technologies to create counter-pressures in the mould (to avoid foam formation at the feed front during mould filling) and the core-back technology (to induce an abrupt reduction of pressure in the mould through a sudden increase in mould volume).

However, it is very difficult or impossible to avoid the premature formation of foam. The current state of the art in foam injection moulding approaches this issue by using a post-injection solubilisation stage, in which the early bubbles are allowed to melt again under pressure to form again the polymer/blowing agent solution, before the abrupt pressure reduction by the core-back system (Ishikawa et al., “Visual Observation and Numerical Studies of N₂ vs. CO₂ Foaming Behavior in Core-Back Foam Injection Molding” Polym. Eng. Sci., Volume 52, Issue 4, Pages 875-883, 2012).

This solution, which is common today, is expensive, complex and unlikely to lead to the production of foamed products with a relative density under 0.5 with respect to the density of the starting polymer.

### SUMMARY OF THE INVENTION

The Applicant has addressed the issue of making products comprising expanded polymeric materials by means of injection molding. In this area, the Applicant has found a different solution, which avoids the complex management of the polymer/blowing agent solution in the extruder and of the injection of the solution into the mold to produce foamed plastic objects with complex geometry.

The Applicant has found a process which uses a preform of the polymeric material to be inserted into a mold, in which the blowing agent is solubilized at high pressure and temperature in the polymeric material of the preform and in which at the end of the solubilization the pressure is abruptly released to allow the desorption of the blowing agent and the consequent expansion to take place. In the context of the process of the present invention, the mold used comprises a cavity having a volume equal to or greater than the overall volume of the preform and a geometry corresponding to the product to be made.

Considering the mass transport properties, represented by the diffusion of blowing agent in the polymer, at the working temperatures, the Applicant has found that the preform has to be made in such a way as to:
speed up the solubilization step,
determine, through foaming, the desired degree of foaming.
determine the complete filling of the mold with the appropriate increase in volume following the expansion.

The Applicant has found that the preform must comprise, at least in part, thin structures, with a characteristic dimension of the millimetre, preferably of the tenth of a millimetre, in which the solubilisation times of the blowing agent are of the order of seconds, up to tens of seconds.

The Applicant has also observed that the empty spaces delimited by the thin structures are preferably connected in such a way as to allow the blowing agent to flow into all the cavities defined by the preform.

The Applicant has also found that in this way, depending on the shape, dimension and spatial distribution of the thin structures and according to the shape and dimension of the mold, it is possible to design in detail the spatial distribution of the foam density, as well as of the polymer structure in terms of molecular orientations and of orientation and degree of the crystalline phase.

The Applicant has also observed that, from the precise definition of the spatial distribution of the foam density as well as of the polymer structure, it is possible to locally confer isotropic or anisotropic properties to the material, such as trigonal, rhombohedral, orthotropic characteristics.

The Applicant has also observed that to speed up the solubilisation and make the expansion into the desired areas possible, the preform polymer can be heated locally before the solubilisation.

Again, the reduced thickness of the thin structures and the characteristic properties of the polymeric material allow this step to be conducted quickly, with characteristic times in the order of seconds, up to tens of seconds.

The Applicant has also observed that the above-mentioned heating can take place by injection of blowing agent at the appropriate temperature to bring the polymeric material to the desired temperature.

Thermal and mass diffusivities typical of polymers allow that, if the characteristic thickness interested in the transport mechanism is of the order of mm, the characteristic time to heat up and the characteristic time to saturate the interested volume of polymer with blowing agent are of the order of 1-10 seconds, compatible with company productivity and current production processes/standards.

With the present invention, with respect to the foam injection molding technology, the extruder is simplified, as it is no longer necessary to inject the blowing agent into the barrel (valves, injectors, feeders, special screw configuration and length, to allow complete solubilisation of the blowing agent), the complex core-back operation is not necessary, with the plant part, core-back times and geometrical constraints to the mold. With the present invention, current limits on the density of products for foam injection molding are overcome. As a matter of fact, no products are currently made with a relative density lower than 0.5.

With the present invention, by modulating the saturation and heating times, the dimension of the thin layers and their positioning and geometries in the preform, it is possible to finely and locally modulate the spatial distribution of the density, as well as the orientation of the bubbles and the structure of the polymer in terms of, for example, molecular orientation and orientation and degree of crystallinity.

A first aspect of the present invention is therefore a process for making a product comprising a polymeric material expanded by using one or more blowing agents characterised in that said process comprises the following steps:
to make a polymeric material preform with a filling degree equal to or less than 90% and thin structures having a thickness equal to or less than 3 mm, preferably equal to or less than 2 mm,
to make a mold including a cavity, said cavity having the shape of the desired product and dimensions equal to or greater than the overall volume of said preform,
to insert the preform into said cavity of the mold,
to solubilize under pressure one or more blowing agents in the preform within said mold cavity,
to release the pressure, and
to remove the product comprising the expanded polymeric material from the mold.

### SHORT DESCRIPTION OF FIGURES

FIG. 1 shows a CAD model (a) of the preform of the example 1 and (b) of the preform of the example 2.

FIG. 2 shows a part in detail of CAD model (a) of the preform of the example 1 and (b) of the preform of the example 2.

FIG. 3 shows the print result (a) of the preform of the example 1 and (b) of the preform of the example 2.

FIG. 4 a part in detail of the print result (a) of the preform of the example 1 and (b) of the preform of the example 2.

FIG. 5 shows the object resulting after the solubilisation and the expansion (a) of the example 1 and (b) of the example 2.

FIG. 6 shows a CAD model (a) of a preform for making a helmet with a filling degree of about 70% and (b) of a detail thereof.

FIG. 7 shows a CAD model (a) of a preform for making a helmet with a filling degree of approximately 50% and (b) of a detail thereof.

FIG. 8 shows a CAD model (a) of a preform for making a helmet with a filling degree “a gradient”, consisting of a first layer at 50% and a second at 25% and (b), (c), and (d) of a detail thereof.

FIG. 9 shows a CAD model (a) of the resulting helmet and (b) of a detail thereof.

FIG. 10 shows a CAD model of the preform (a) and of the expanded product (b) and the picture of the real preform (c) and of the expanded product (d-e) made as described in the example 3.

FIG. 11 shows a CAD model of the preform (a) and of the expanded product (b) and the picture of the real preform (c) and of the expanded product (d-e) made as described in the example 4.

FIG. 12 shows a CAD model of the preform (a) and of the expanded product (b) and the picture of the real preform (c) and of the expanded product (d-e) made as described in the example 5.

FIG. 13 shows a CAD model of the preform (a) and of the expanded product (b) and the picture of the real preform (c) and of the expanded product (d-e) made as described in the example 6.

FIG. 14 shows a CAD model of the preform (a) and of the expanded product (b) and the picture of the real preform (c) and of the expanded product (d-e) made as described in the example 7.

FIG. 15 shows a CAD model of the preform (a) and of the expanded product (b) and the picture of the real preform (c) and of the expanded product (d-e) made as described in the example 8.

FIG. 16 shows a CAD model of the preform (a) and of the expanded product (b) made as described in the example 9.

FIG. 17 shows a CAD model of the preform (a) and of the expanded product (b) made as described in the example 10.

### DETAILED DESCRIPTION OF THE INVENTION

The expression “polymeric material” indicates a polymeric material comprising a thermoplastic homo-polymer or co-polymer.

The expression “expandible polymeric material” indicates a polymeric material capable of absorbing a blowing agent at a certain temperature and under pressure, of allowing the nucleation and growth of bubbles when the pressure is released, and of withstanding elongational stresses during bubble growth until solidification.

The expression “blowing agent” indicates a substance capable of causing the expansion of the polymeric material through the formation of bubbles within the polymeric material. The term “expanded polymeric material” indicates a polymeric material within which bubbles were formed by means of a blowing agent.

The expression “filling degree” referred to the preform indicates the ratio between the volume of material actually used to make the preform on the millimetre or sub-millimetre scale and the macroscopic volume, or overall volume, occupied by the preform itself, including in this volume, or overall volume, the millimetre or sub-millimetre spaces not actually occupied by the material. The filling degree is a complementary index of the amount of void in the preform, this amount of void being the greater the lower the value of the filling degree.

The term “cavity of the mold” indicates the space available of the preform to make, at the time of the expansion, the final object. The cavity of the mold is greater than or equal to the overall volume of the preform, and is capable of containing the same.

The term “density” indicates the ratio between the weight of a given volume of a polymeric material layer and that volume.

The term “relative density” indicates the ratio of density between the expanded polymeric material and the starting polymer.

The term “thin structure” indicates any shape or mass distribution in which at least one characteristic dimension is small and lower than the others. This definition includes, for example, wire (spaghetti), parallel-laminated, folded or twisted structures and cavity structures.

The term “morphology” indicates the shape, dimension, numerosity and distribution per unit of volume of the bubbles formed within the expanded polymeric material.

A first object of the present invention is represented by a process for making a product comprising a polymeric material expanded by using one or more blowing agents characterized in that said process comprises the following steps:
to make a preform of polymeric material with a filling degree equal to or lower than 90% and thin structures having a thickness equal to or lower than 3 mm, preferably equal to or lower than 2 mm,
to make a mold including a cavity, said cavity having the shape of the desired product and dimensions equal to or greater than the overall volume of said preform,
to insert the preform into said cavity of the mold,
to solubilize under pressure one or more blowing agents in the preform within said mold cavity,
to release the pressure, and
to remove the product comprising the expanded polymeric material from the mold.

According to the first object of the invention, said polymeric material is preferably selected from the group consisting of thermoplastic polymeric materials.

Advantageously, said thermoplastic polymeric materials are selected from the group comprising polyolefins, polyurethanes, polyesters, polyamides, and mixtures thereof. Preferably, said polymeric materials are polymers and copolymers of styrene, ethylene, propylene, and other olefins, such as for example polystyrene, polyethylene, and polypropylene, and mixtures thereof. Optionally, said polymeric materials may comprise one or more co-monomers. Co-monomers may include, for example, alkylstyrenes, divinylbenzene, acrylonitrile, diphenylether, alpha-methylstyrene, or combinations thereof. By way of example, the polymeric material may comprise from about 0% by weight to about 30% by weight, preferably from about 0.1% by weight to about 15% by weight, and more preferably from about 1% by weight to about 10% by weight of co-monomer.

Preferably, polymeric materials can show a molecular weight Mw (measured by GPC) ranging from about 10,000 Daltons to about 500,000 Daltons, more preferably ranging from about 150,000 Daltons to about 400,000 Daltons, and even more preferably from about 200,000 Daltons to about 350,000 Daltons.

Advantageously, polymeric materials show a melt flow index, measured according to ASTM D 1238 at temperature 200° C. and load 10 kg, ranging from 1.0 to 20 g/10 min. In an embodiment, the polymeric material can be mixed with a fibrous material, preferably selected from natural plant and animal fibres, mineral fibres, and synthetic fibres. Plant fibres are for example cotton, flax and hemp fibres. Animal fibres are for example wool and silk fibres. Mineral fibres are for example carbon fibres and silicate fibres, such as for example glass fibres, chrysotile fibres, sepiolite, paligorskite (also known as attapulgite), wollastonite, imogolite, and mixtures thereof. Synthetic fibres are for example polyester fibres, polyamide fibres (nylon), acrylic, aramid (Kevlar and nomex), vinyl, polyalkylene (polyethylene and polypropylene), polytetrafluoroethylene (Gore-tex), and polyurethane (Elastam) fibers.

The polymeric material can comprise a quantity of fibrous material ranging from 5% to 70% in volume, preferably ranging from 10% to 50% in volume, with respect to the volume of the polymeric material.

The preform can be made using methods known in the art such as injection molding, compression molding, 3D molding, rotational molding, blow molding, extrusion molding, and by thermoforming, lamination, additive production and subtractive production.

The preform can also be made directly in the mold using a counter mold in a step prior to the solubilisation.

In any case, the geometry of the preform is at first processed by means of three-dimensional computer models created with CAD/CAM/CAE specific software (for example, Solidworks™ and CATIA™ of Dassault Systèmes, AutoCAD™ of Autodesk). The models thus made are then transferred to the production plant.

Advantageously, the preform in polymeric material has a filling degree equal or lower than 70%, preferably lower than 50%.

The applicant has observed that a lower filling degree allows a greater amount of voids within the preform capable of quickly circulating the blowing agent within the preform. At the same time, the applicant has observed that the solubilisation of the blowing agent in the polymeric material of the preform is faster as the thickness of the thin structures of the preform itself.

Advantageously, the thin structures of the preform have a thickness greater than 0.1 mm, preferably greater than 0.2 mm, more preferably greater than 0.3 mm, and even more preferably greater than 0.4 mm. Particularly, the thin structures of the preform have a thickness lower than 2 mm, preferably lower than 1.9 mm, more preferably lower than 1.7 mm, and even more preferably lower than 1.6 mm. According to a particularly preferred embodiment, the thin structures of the preform have a thickness ranging from 0.5 to 1.5 mm.

The applicant has observed that the thin structures of the preform with the indicated thicknesses allow one to obtain a quick and uniform solubilisation of the blowing agent within the polymeric material, avoiding the drawbacks known in the art.

The thin structures of the preform may consist of lamellae and/or filaments, eventually interconnected with each other to form a three-dimensional structure. The lamellae and/or filament structure allows to build a preform with the desired filling degree, leaving within the preform hollow spaces interconnected with each other through which the blowing agent can be conveyed more effectively in the areas where the lamellae or filaments are located and be absorbed by the polymeric material during the solubilisation step more advantageously with respect to the areas with a greater characteristic dimension.

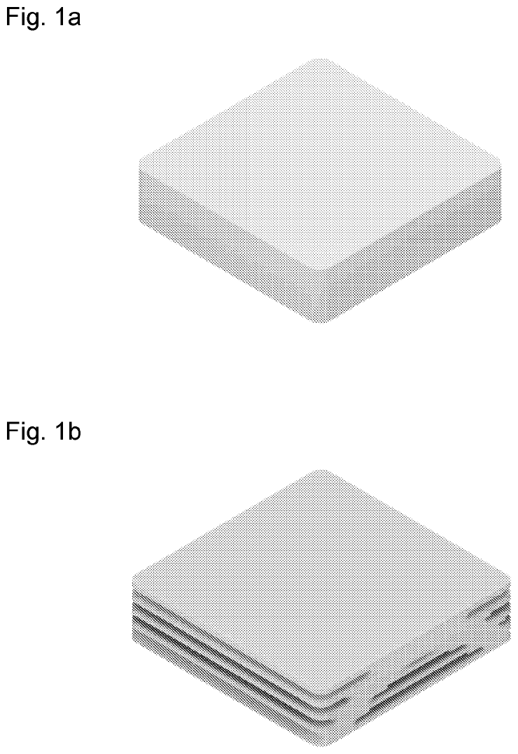

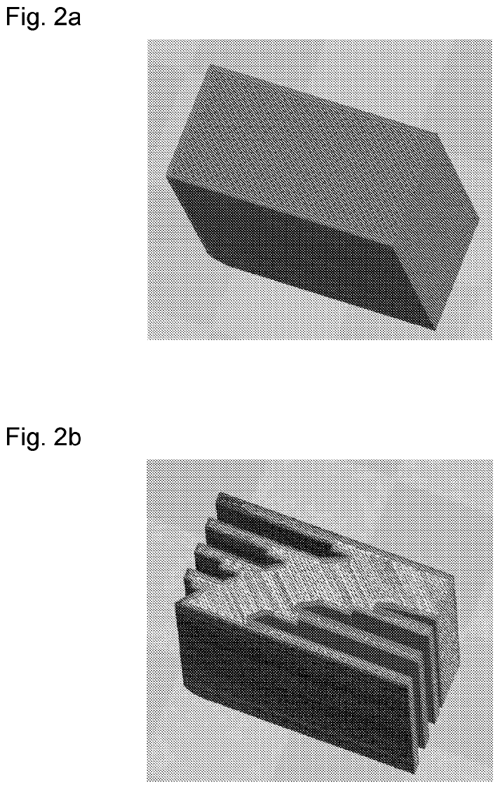

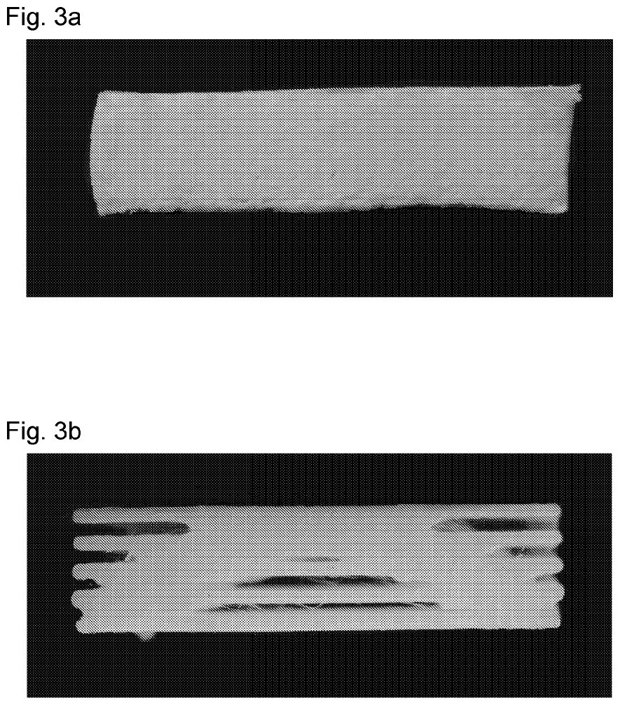

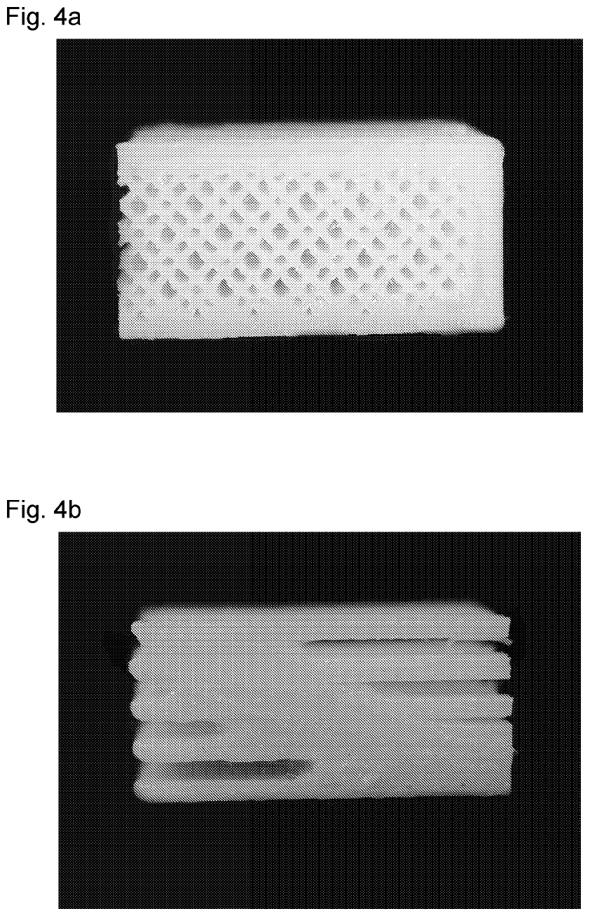

The preform can have a uniform structure or a gradient structure. The uniform structure presents a uniform distribution of the structure of the preform, such as for example the structure exemplified in FIGS. 1a-4a, in which the filling degree is uniform in the entire preform. The gradient structure presents a variable distribution of the structure of the preform, such as for example the structure exemplified in FIGS. 1b-4b, in which there are portions with different filling degree.

The structure and final shape of the preform are not particularly limited, and can take on any appearance achievable according to methods known in the art and according to the shape and dimension requirements of the object to be made.

According to the first object of the invention, the solubilization step is conducted with a blowing agent or with a mixture of two or more blowing agents, preferably with a mixture of two blowing agents.

According to the first object of the invention, said one or more blowing agents are selected from the group consisting of inert gases, carbon dioxide, and aliphatic hydrocarbons (linear, branched or cyclic) substituted or unsubstituted having from 3 to 8 carbon atoms.

Advantageously, the blowing agent is selected from the group which comprises nitrogen, carbon dioxide, n-butane, iso-butane, n-pentane, and iso-pentane. Preferably, the substituted aliphatic hydrocarbons comprise halogenated hydrocarbons, in particular chlorocarbons, chlorofluorocarbons and fluorocarbons, such as, for example, 1,1,1,2-tetrafluoroethane (Freon R-134a), 1,1-difluoroethane (Freon R-152a), difluoromethane (Freon R-32), pentafluoroethane (Freon R-125).

According to the first object of the invention, the solubilization step is preferably carried out at a temperature ranging from 20° to 350° C., more preferably ranging from 30° to 250° C., and advantageously ranging from 50° to 200° C.

According to the first object of the invention, the solubilization step is preferably conducted at a pressure ranging from 20 to 400 bar, preferably ranging from 40 to 300 bar, more preferably ranging from 60 to 250 bar, and even more preferably ranging from 80 to 200 bar.

Advantageously, the solubilization step comprises a stabilization step under isobaric and isothermal conditions for a period ranging from 5 to 300 seconds, preferably ranging from 10 to 180 seconds, more preferably ranging from 15 to 120 seconds.

Preferably, according to the first object of the present invention, the pressure is released instantly at a rate not less than 20 bar/s, preferably not less than 50 bar/s, more preferably not less than 100 bar/s.

The release of the pressure causes the desorption and the expansion of the blowing agent solubilized within the polymeric material of the preform, and the consequent formation of bubbles within the polymeric material, with formation of the expanded polymeric material having the desired shape.

The morphology and density of the expanded polymeric material may be uniform or gradient depending on the distribution of the structure of the preform and the saturation history.

In particular, the solubilization step can be carried out with a pressure history of one or more blowing agents constant or time-varying, in a periodic or non-periodic manner, with a waveform of, for example, a sinusoidal, triangular, square, sawtooth type, or combinations thereof, as described, for example, in the international patent applications published with the number WO2019/202407 and WO2021/014371.

Using a time-varying pressure history it is possible to make a multi-layer structure which comprises at least two layers having different density and/or morphology without discontinuities of morphology and density at the interface between said at least two layers.

Advantageously, the solubilization step can be conducted by varying the concentration of the blowing agent over time. In particular, the concentration of the blowing agents can vary over time.

The solubilization step by varying the pressure or concentration of the blowing agents over time determines the formation of different concentration profiles of the blowing agents in the different areas of the preform according to what is required to locally obtain the desired expansion and flow rates to confer a defined 3D map of density, structure, morphology, material and porosity orientation to the piece.

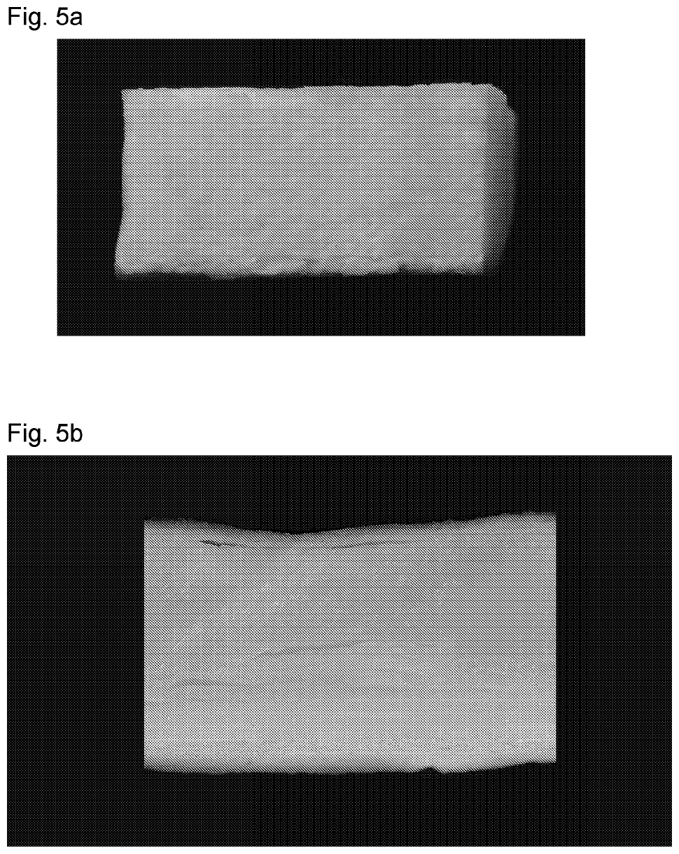

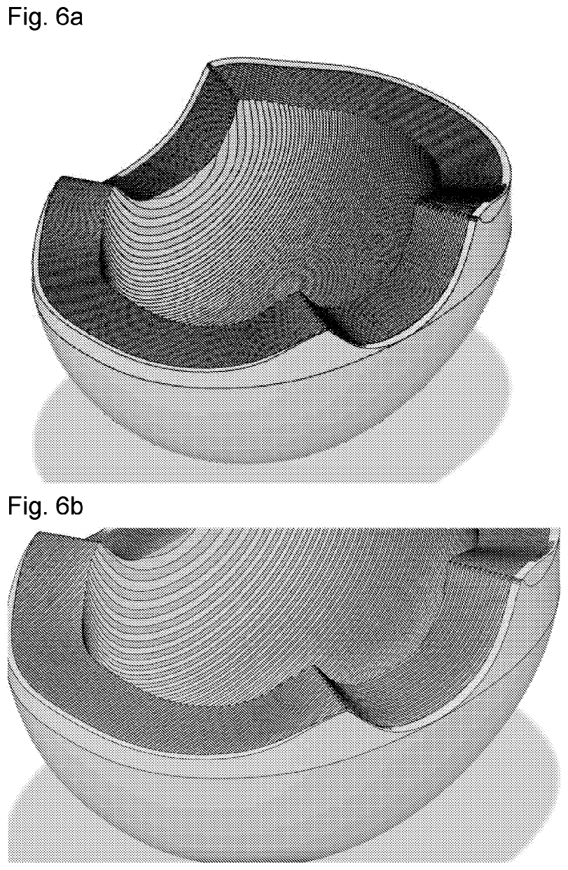

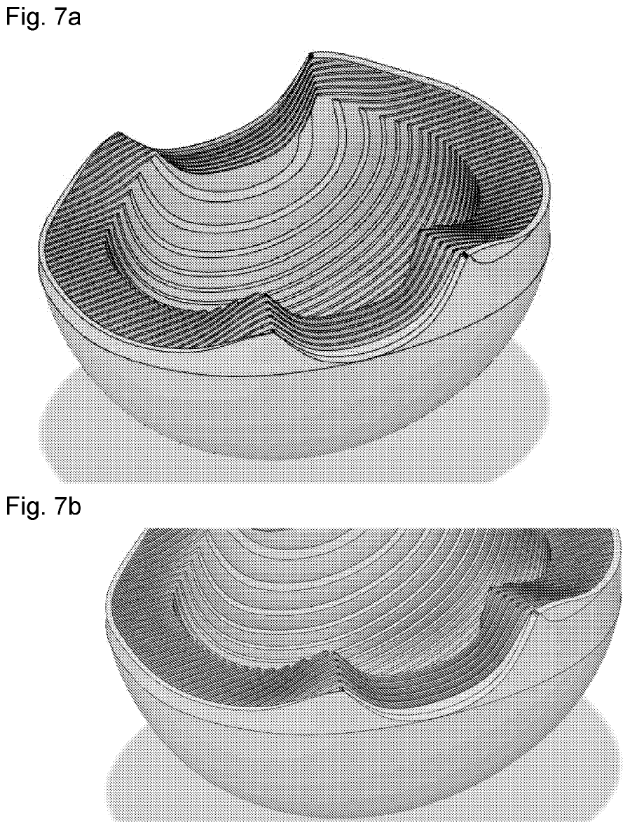

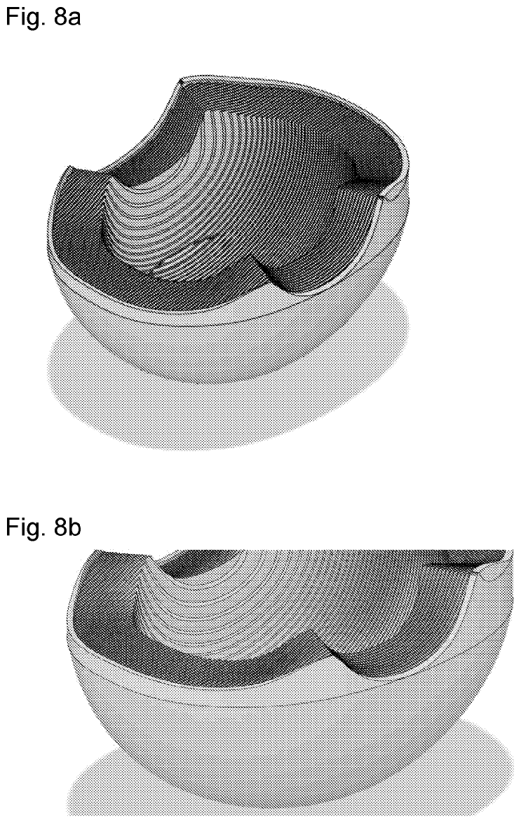

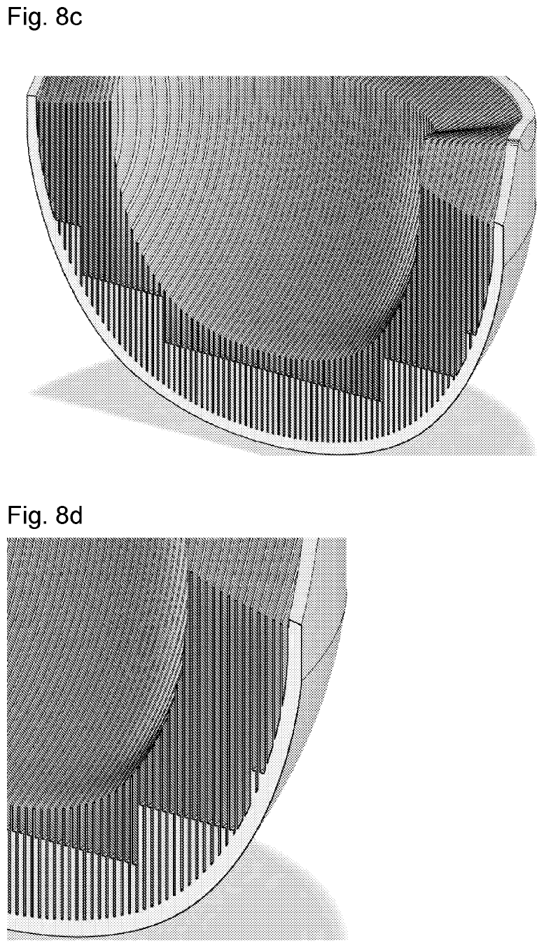

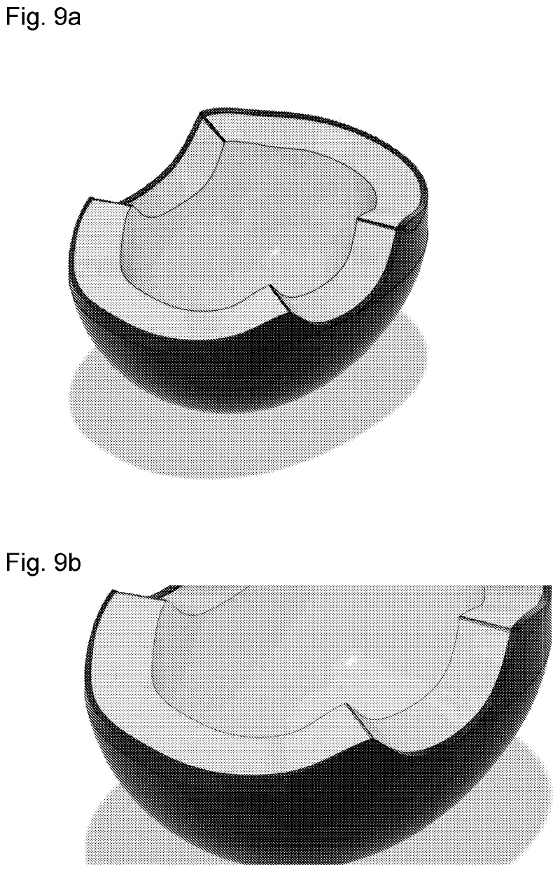

FIG. 5a shows the object obtained with the preform of example 1, with which an expanded polymeric material with uniform morphology and density was obtained.

FIG. 5b shows the object obtained with the preform of the example 2, with which an expanded polymeric material with variable morphology and density was obtained, with formation of a partially foamed structure inside the parallelepiped substantially corresponding to the arched structure with 100% filling level of the preform with a morphology and a density different with respect to the mostly foamed structure substantially corresponding to the lamellar structure.

The present invention will now be explained with reference to materials and methods described for explanatory, but not limiting purposes, in the following experimental part.

### EXPERIMENTAL PART

### Example 1 (Uniform Expanded Material)

A preform consisting of a parallelepiped having dimensions 40 mm×40 mm×10 mm of thermoplastic polyurethane (TPU 3D Printer Filament—YOYI) was produced through a 3D printer (Cetus MKIII 3D Printer—Tiertime) with filling degree equal to 50% and thickness characteristic of the thin structures of 0.5 mm. The preform as a whole and in detail is shown in FIGS. 1a-4a.

The preform was then included into a mold comprising a cavity having the same dimensions as the overall volume of the preform, and subjected to a process described by the following steps:
1. heating from room temperature to 130° C. in 15 minutes;
2. pressurisation from ambient pressure to 100 bar in 2 minutes with CO₂;
3. waiting under isobaric and isothermal conditions for 30 s;
4. release of pressure at the rate of 100 bar/s.

At the opening of the mold, the object obtained from the preform (shown in FIG. 5a) was uniformly expanded, with relative density 0.5 and average bubble dimension of about 200 micron.

### Example 2 (Gradient Expanded Material)

A preform consisting of a parallelepiped having dimensions 40 mm×40 mm×10 mm of thermoplastic polyurethane (TPU 3D Printer Filament—YOYI) was produced through a 3D printer (Cetus MKIII 3D Printer—Tiertime).

The preform, shown as a whole and in detail in FIGS. 1b-4b, consists of an arch with filling degree of 100% and thin lamellae having a thickness of about 0.5 mm with filling degree of 30% distributed in the volume so as to occupy it all. The total mass of the object was identical to the object of the example 1.

The preform was then included in a mold comprising a cavity having the same dimensions as the overall volume of the preform, and subjected to a process described by the following steps:
1. heating from room temperature to 130° C. in 15 minutes;
2. pressurisation from ambient pressure to 100 bar in 2 minutes with CO₂;
3. waiting under isobaric and isothermal conditions for 30 s;
4. release of pressure at the rate of 100 bar/s.

At the opening of the mold, the object obtained from the preform (shown in FIG. 5b) resulted expanded, with average relative density 0.5. However, the conformation of the preform resulted in the creation of a complex structure partially foamed inside the parallelepiped, which is not appreciable to the naked eye.

### Example 3

A preform with overall volume of dimensions 40 mm×40 mm×9 mm of thermoplastic polypropylene (E02ES of Sinopec Shanghai Gaoqiao Company) was produced through hot molding.

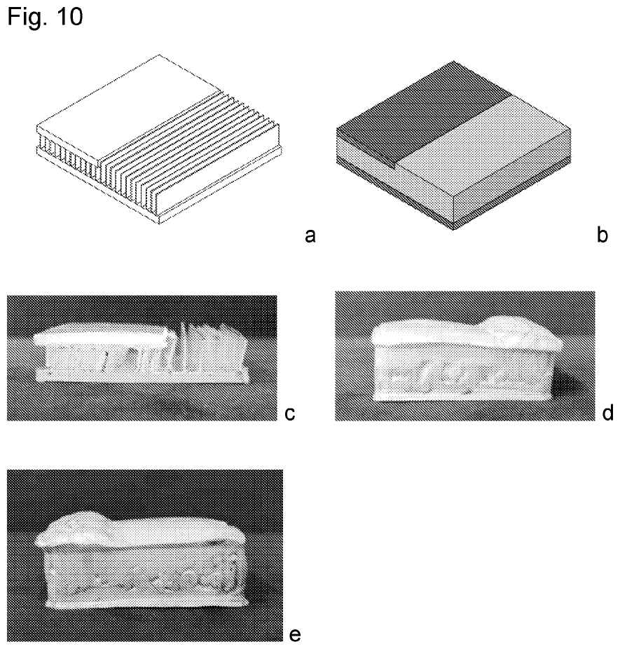

The preform with filling degree 45%, shown in FIGS. 10a (CAD) and 10c (real object), is formed by vertical lamellae with a thickness of about 0.4 mm and two horizontal lamellae with a thickness of about 2 mm.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 100 bar in 10s with CO₂;
3. release of pressure at the rate of 100 bar/s.

At the opening of the mold, the object obtained from the preform (shown in FIG. 10b (CAD) and 10d-e (expanded real object)) resulted expanded, with average relative density of 0.10 g/cm³. However, the conformation of the preform has determined the making of a complex structure with a high density and unfoamed zone (0.95 g/cm³) indicated in dark grey in FIG. 10b, and a low density expanded zone (0.09 g/cm³) indicated in light grey in FIG. 10b, appreciable to the naked eye also in FIGS. 10d-e.

### Example 4

A preform with overall volume of dimensions 40 mm×40 mm×9 mm of thermoplastic polypropylene (E02ES of Sinopec Shanghai Gaoqiao Company) was produced through hot molding.

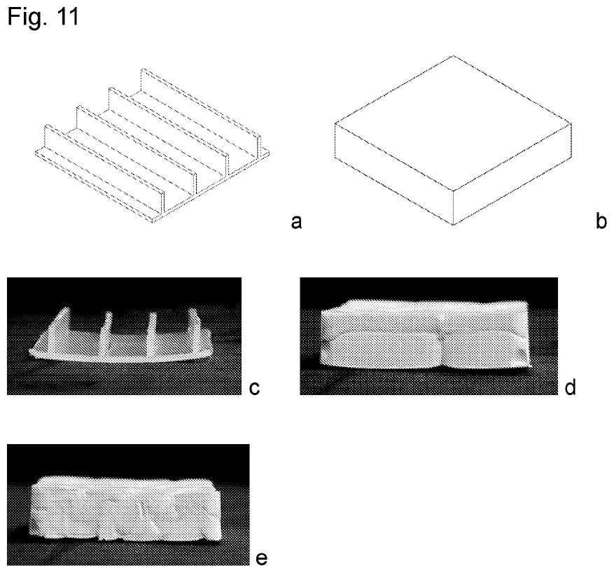

The preform with filling degree 20%, shown in FIGS. 11a (CAD) and 11c (real object), is formed by lamellae with a thickness of about 1.0 mm placed perpendicularly to a flat plate with a thickness of about 1.0 mm.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 2 minutes with CO₂;
3. waiting under isobaric and isothermal conditions for 1 minute;
4. release of pressure at the rate of 100 bar/s.

At the opening of the mold, the object obtained from the preform (shown in FIGS. 11b (CAD) and 11d-e (expanded real object)) resulted expanded, with average relative density of 0.10 g/cm³.

### Example 5

A preform with overall volume of dimensions 40 mm×40 mm×9 mm of thermoplastic polypropylene (E02ES of Sinopec Shanghai Gaoqiao Company) was produced through hot molding.

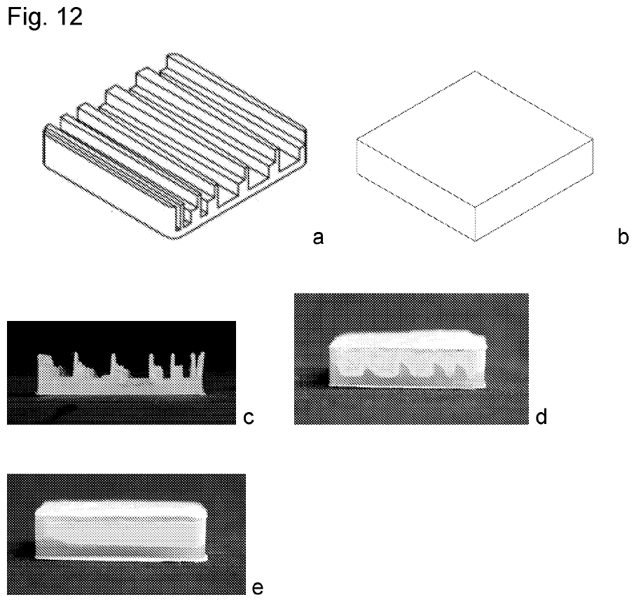

The preform with filling degree 67%, shown in FIGS. 12a (CAD) and 12c (real object), is formed by vertical lamellae with a variable thickness gradient, both in vertical and horizontal directions, from a maximum of 3 mm to a minimum of 1 mm.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 2 minutes with CO₂;
3. waiting under isobaric and isothermal conditions for 1 minute;
4. release of pressure at the rate of 100 bar/s.

At the opening of the mold, the object obtained from the preform (shown in FIGS. 12b (CAD) and 12d-e (expanded real object)) resulted expanded, with average relative density of 0.65 g/cm³. However, the conformation of the preform has determined the making of a complex structure with a lower high density unfoamed zone (0.95 g/cm³) visible in dark grey in FIGS. 12d-e, and a low density expanded zone (0.11 g/cm³) visible in light grey in FIGS. 12d-e.

### Example 6

A preform with overall volume of dimensions 40 mm×40 mm×9 mm of thermoplastic polypropylene (E02ES of Sinopec Shanghai Gaoqiao Company) was produced by hot molding and by assembling two lamellae with thickness of 2 mm obtained by compression molding of thermoplastic polypropylene with flax fibres (40% by volume) in an aluminium mold at 200° C. with 5 lamellae with thickness 1 mm obtained by compression molding of thermoplastic polypropylene in an aluminium mold at 180° C.

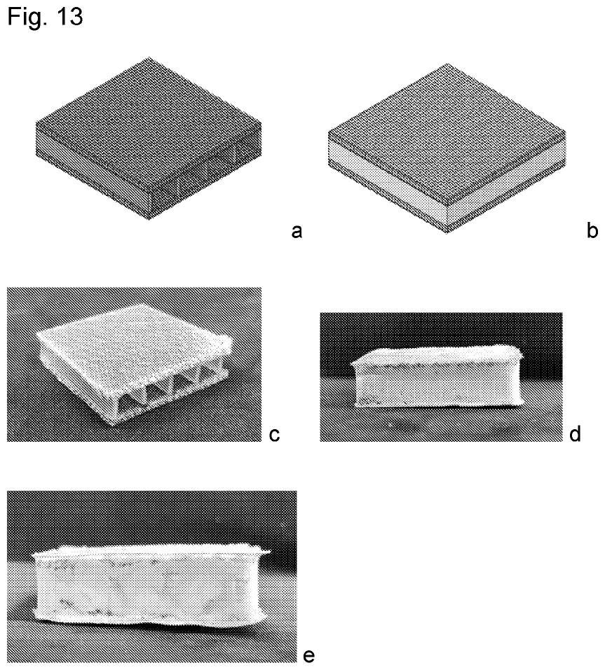

The preform, with filling degree 67%, is shown in FIGS. 13a (CAD) and 13c (real object). The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 2 minutes with CO₂;
3. waiting in isobaric and isothermal conditions for 1 minute;
4. Release of pressure at a rate of 100 bar/s.

At the opening of the mold, the object obtained from the preform (shown in FIGS. 13b (CAD) and 13d-e (expanded real object)) resulted expanded, with average relative density of 0.65 g/cm³. The object obtained was a thermoplastic sandwich with external polypropylene walls with fibrous reinforcement and an internal core of polypropylene foam. In particular, the thickness of the internal foam core had a constant thickness equal to about 5 mm.

### Example 7

A preform with overall volume of dimensions 40 mm×40 mm×9 mm of thermoplastic polypropylene (E02ES of Sinopec Shanghai Gaoqiao Company) was produced by hot molding and by assembling two lamellae with thickness of 2 mm obtained by compression molding of thermoplastic polypropylene with flax fibres (40% by volume) in an aluminium mold at 200° C. with 4 lamellae with thickness 1 mm obtained by compression molding of thermoplastic polypropylene in an aluminium mold at 180° C.

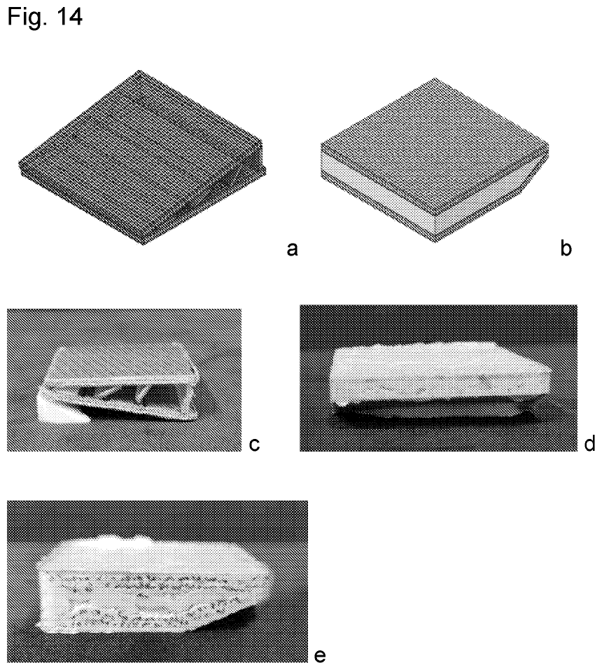

The preform, with filling degree 50%, is shown in FIGS. 14a (CAD) and 14c (real object). The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 2 minutes with CO₂;
3. waiting in isobaric and isothermal conditions for 1 minute;
4. release of pressure at a rate of 100 bar/s.

At the opening of the mold, the object obtained from the preform (shown in FIGS. 14b (CAD) and 14d-e (expanded real object)) resulted expanded, with average relative density of 0.5 g/cm³. The object obtained was a thermoplastic sandwich with external polypropylene walls with fibrous reinforcement and an internal core of polypropylene foam. In particular, the thickness of the internal foam core had a constant thickness variable from about 5 mm to zero, on the thinner side.

### Example 8

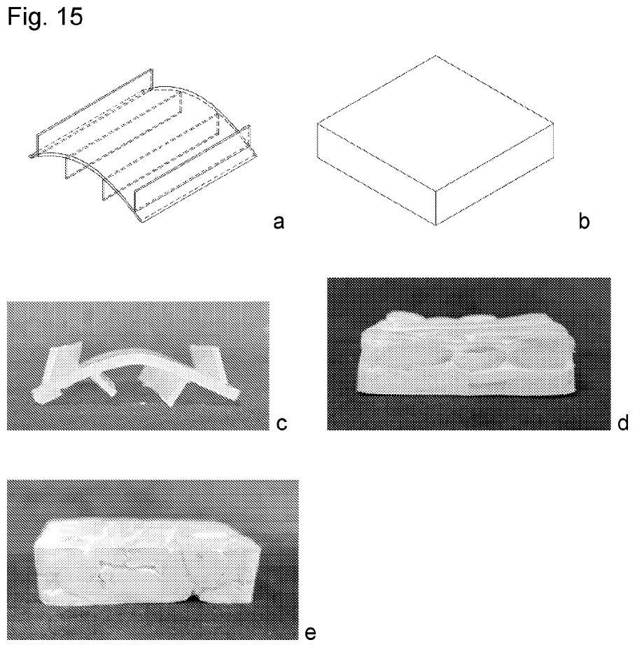

A preform with overall volume of dimensions 40 mm×40 mm×9 mm of thermoplastic polypropylene (E02ES of Sinopec Shanghai Gaoqiao Company) was produced by hot molding. The preform with filling degree 15%, shown in FIGS. 15a (CAD) and 15c (real object), is formed by vertical lamellae having thickness of about 1 mm and a curved lamella having thickness of about 2 mm.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 2 minutes with CO₂;
3. waiting in isobaric and isothermal conditions for 1 minute;
4. release of pressure at a rate of 100 bar/s.

At the opening of the mold, the object obtained from the preform (shown in FIGS. 15b (CAD) and 15d-e (expanded real object)) resulted expanded, with average relative density of 0.15 g/cm³.

### Example 9

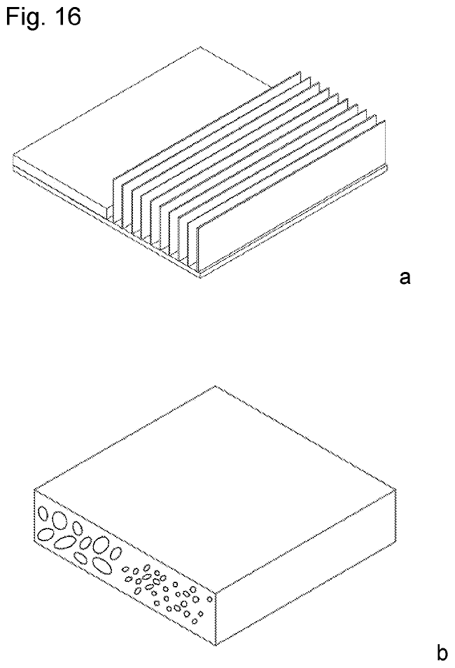

A preform with overall volume of dimensions 40 mm×40 mm×9 mm of thermoplastic polypropylene (E02ES of Sinopec Shanghai Gaoqiao Company) was produced by hot molding. The preform, shown in FIGS. 16a (CAD) is formed by vertical lamellae having thickness of about 0.4 mm for one half and by a lamella of 2 mm for the other half. All the lamellae are held together by a flat plate of 0.4 mm thickness.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 10 minutes with CO₂;
3. gas exchange at 120 bar from CO₂ to N₂ in 10 s.
4. release of pressure at a rate of 100 bar/s.

At the opening of the mold, the object obtained from the preform (shown in FIG. 16b (CAD) resulted expanded, with an average relative density of 0.2 g/cm³. In this way, the part deriving from the thickness of 2 mm foamed with CO₂, with a bubble morphology of approximately 100 μm and the part deriving from the lamellae of 0.4 mm foamed with N₂ with a bubble morphology of approximately 10 μm. The density of each part is of about 0.2 g/cm³, given by the filling degree, in this case equal between the two parts and of 20%.

### Example 10

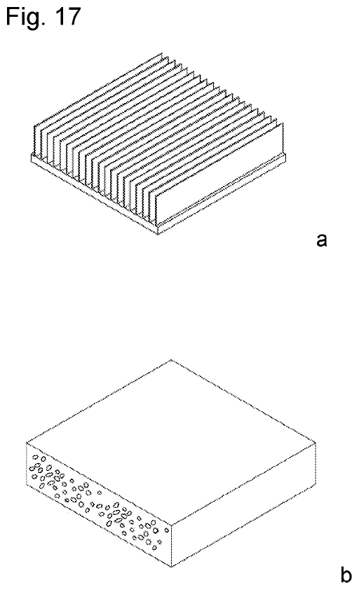

A preform with overall volume of dimensions 40 mm×40 mm×9 mm of thermoplastic polypropylene (E02ES of Sinopec Shanghai Gaoqiao Company) was produced by hot molding. The preform, with filling degree 20%, shown in FIG. 17a (CAD) is formed by vertical lamellae having thickness of about 0.4 mm. All the lamellae are held together by a flat plate of 0.4 mm thickness.

The preform was then included in a mold comprising a cavity having the same dimensions as the overall volume of the preform, and subjected to a process described by the following steps:
1. heating from room temperature to 156° C. in 15 minutes followed by the stabilization of the temperature at 142° C.;
2. pressurisation from ambient pressure to 120 bar in 10 seconds with N₂;
3. release of pressure at a rate of 100 bar/s.

At the opening of the mold, the object obtained from the preform (shown in FIG. 17b (CAD)) resulted in a uniform expansion with an average relative density of 0.2 g/cm³.

1. A process for making a product comprising a polymeric material expanded by using one or more blowing agents characterized in that said process comprises the following steps:
to make a preform of polymeric material with a filling degree equal to or less than 90% and thin structures having a thickness equal to or less than 3 mm, preferably equal to or less than 2 mm,
to make a mold including a cavity, said cavity having the shape of the desired product and dimensions equal to or greater than the overall volume of said preform,
to insert the preform into said cavity of the mold,
to solubilize under pressure one or more blowing agents in the preform within said mold cavity,
to release the pressure, and
to remove the product comprising the expanded polymeric material from the mold.

2. The process according to claim 1, characterized in that said preform of polymeric material has a filling degree equal to or less than 70%, preferably less than 50%.

3. The process according to claim 1, characterized in that said thin structures of the preform have a thickness greater than 0.1 mm, preferably greater than 0.2 mm, more preferably greater than 0.3 mm, and even more preferably greater than 0.4 mm.

4. The process according to claim 1, characterized in that said thin structures of the preform have a thickness lower than 2 mm, preferably lower than 1.9 mm, more preferably lower than 1.7 mm, and even more preferably lower than 1.6 mm.

5. The process according to claim 1, characterized in that said solubilization step is conducted at a temperature ranging from 20° to 350° C., preferably ranging from 30° to 250° C., and more preferably ranging from 50° to 200° C.

6. The process according to claim 1, characterized in that said solubilization step is conducted at a pressure ranging from 20 to 400 bar, preferably ranging from 40 to 300 bar, more preferably ranging from 60 to 250 bar, and even more preferably ranging from 80 to 200 bar.

7. The process according to claim 1, characterized in that said solubilization step is carried out with a pressure history of said one or more blowing agents that is constant or time-varying.

8. The process according to claim 7, characterized in that said pressure history varies over time in a periodic or non-periodic manner, with a waveform of, for example, a sinusoidal, triangular, square, sawtooth type, or combinations thereof.

9. The process according to claim 7, characterized in that said solubilization step is carried out with a time-varying concentration history of said blowing agents.

10. The process according to claim 1, characterized in that said solubilization step comprises a stabilization step under isobaric and isothermal conditions for a period ranging from 5 to 300 seconds, preferably ranging from 10 to 180 seconds, more preferably ranging from 15 to 120 seconds.

11. The process according to claim 1, characterized in that said pressure is released at a rate of not lower than 20 bar/s, preferably not lower than 50 bar/s, more preferably not lower than 100 bar/s.

12. The process according to claim 1, characterized in that said one or more blowing agents are selected from the group consisting of inert gases, carbon dioxide, and aliphatic hydrocarbons (linear, branched or cyclic) substituted or unsubstituted having from 3 to 8 carbon atoms.

13. The process according to claim 1, characterized in that said one or more blowing agents are selected from the group consisting of nitrogen, carbon dioxide, n-butane, iso-butane, n-pentane, and iso-pentane.

14. The process according to claim 1, characterized in that said polymeric material used for making said preform comprises fibrous material.

15. The process according to claim 14, wherein said fibrous material is selected from the group consisting of natural plant and animal fibres, mineral fibres, and synthetic fibres.

16. The process according to claim 14, wherein said polymeric material comprises a quantity of fibrous material ranging from 5% to 70% in volume, preferably ranging from 10% to 50% in volume, with respect to the volume of the polymeric material.

17. The process according to claim 1, characterized in that said step of making of the preform is carried out in said cavity of the mold.
